(19) United States
(12) Patent Application Publication
(10) Pub. No.: US 2026/0206766 A1
(43) Pub. Date: Jul. 23, 2026

(54) REDOX-ACTIVE IODINE MATRIX COMPOSITION AND ASSOCIATED METHODS FOR PLANT PHYSIOLOGICAL MODULATION

(71) Applicant: GREENER ORIGINS CORP., Santa Clara (PA)

(72) Inventors: Marcelo CALVO, San Salvador (SV); Mario FUENTES, San Salvador (SV)

(21) Appl. No.: 19/571,606

(22) Filed: Mar. 19, 2026

Related U.S. Application Data
(63) Continuation-in-part of application No. PCT/IB2024/059462, filed on Sep. 27, 2024.
(60) Provisional application No. 63/585,981, filed on Sep. 28, 2023.

(51) Int. Cl. A01N 59/12; A01N 25/22; A01P 21/00; C05D 1/00; C05D 9/02; C05G 5/23

(52) U.S. Cl. CPC A01N 59/12; A01N 25/22; A01P 21/00; C05D 1/00; C05D 9/02; C05G 5/23

(57) ABSTRACT

A composition modulates plant physiological processes and includes elemental iodine (I₂) and iodide (I⁻) in an aqueous medium at a weight ratio from about 1:1.2 to about 1:5, iodate (IO₃⁻) present in the aqueous medium at a weight ratio from about 1:0.5 to about 1:5 relative to the combined weight of elemental iodine and iodide, an organic reducing acid, an organic physiological acid, and at least one non-ionic, biodegradable surfactant. The composition forms a redox-active iodine matrix that interconverts iodine species in the aqueous medium.

### PRIORITY APPLICATION(S)

This is a continuation-in-part application which claims priority to International Application No. PCT/IB2024/059462 filed Sep. 27, 2024, which claims priority to U.S. Provisional Patent Application No. 63/585,981 filed Sep. 28, 2023, the disclosures which are hereby incorporated by reference in their entirety.

### FIELD OF THE INVENTION

The present invention relates to redox-active iodine matrix compositions, and more particularly, to compositions that may be used for plant biostimulants and biocatalyzation, growth regulation, an enhancing excipient for organic and inorganic plant fertilizer compounds and formulations and associated methods of making.

### BACKGROUND OF THE INVENTION

The agricultural sector is constantly facing the challenges of raising productivity levs in order to feed the growing global population while increasing resource use efficiency and reducing the environmental impact on ecosystems and human health. A promising and environmental-friendly area of growth has been directed to use of plant biostimulants that enhance flowering, plant growth, fruit set, crop productivity, and nutrient use efficiency. Both of these areas are researched to improve the tolerance against a wide range of abiotic stressors. More than 700 scientific papers have been published in the last 10 years (2009-2019) on plant biostimulants. Some researchers have been able to demonstrate that microbial and non-microbial plant biostimulants are capable of inducing an array of morpho-anatomical, biochemical, physiological, and molecular plant responses such as boosting crop productivity, nutrient use efficiency, and increasing tolerance against abiotic stresses.

A 2019 United States Department of Agriculture report on plant biostimulants provides two definitions for plant biostimulants. The first definition recites, “A naturally occurring substance, its synthetically derived equivalent or a microbe that is used for the purpose of stimulating natural processes in plants or in the soil in order to, among other things: improve nutrient and/or water use efficiency by plants, help plants tolerate abiotic stress, or improve characteristics of the soil as a medium for plant growth. The characteristics may be physical, chemical, and/or biological. The plant biostimulant may be used either by itself or in combination with other substances or microbes for this purpose.”

The second definition recites: “Substance(s), microorganism(s), or mixtures thereof, that, when applied to seeds, plants, the rhizosphere, soil or other growth media, act to support a plant's natural nutrition processes independently of the biostimulant's nutrient content. The plant biostimulant thereby improves nutrient availability, uptake or use efficiency, tolerance to abiotic stress, and consequent growth, development, quality or yield.” FIG. 1 shows a pie chart from Fortune Business Insights of the global biostimulant market share by active ingredients in 2021, showing the larger share by seaweed extracts, followed by humic substances, then vitamins and amino acids, followed by microbial additives and amendments and other sources.

The most common biostimulant substance is Ascophyllum nodosum, which is a seaweed ex?tract used to enhance plant growth and their defense. Seaweed and kelp extracts are related to iodine because they contain the presence of naturally occurring iodinated proteins that are well known in seaweed. For example, the fraction of iodine bound to proteins in Sargassum kjellanianum accounts for 65.5% of the total element content of this organism. With rising populations, climate change and other stressors on plant growth, additional and improved biostimulant compositions are needed to cope with changing dynamics.

### SUMMARY OF THE INVENTION

A composition formulated as a biostimulant for plant growth may comprise elemental iodine and potassium iodide in an aqueous solution at a weight ratio about 1:1.2 to 1:5 and potassium iodate in the aqueous solution at a weight ratio of about 1:0.5 to 1:5 to the combined weight of the elemental iodine and potassium iodide. Ether-nonyl polyglycol ethoxylate may be in the aqueous solution at a weight ratio of about 3:1 to 20:1 to the combined weight of the elemental iodine and potassium iodide to emulsify the elemental iodine and enhance its stability. A first stabilizing agent may comprise salicylic acid in the aqueous solution at a weight ratio of about 1:0.2 to 1:10 to the elemental iodine, and a second stabilizing agent comprising ascorbic acid in the aqueous solution in an amount to enhance solubility and bioavailability of iodine and impart to the aqueous solution a pH between about 4 and 6.

At least one surfactant may comprise one or more of Nonylphenol Ethoxylates; Alcohol ethoxylates/alkoxylates; Sorbitan ester ethoxylates; Alkyl polyglucosides (APG); Polyvinylpyrrolidones (PVP); and Ethylene oxide-propylene oxide copolymers. The ether-nonyl polyglycol ethoxylate may have an ethylene oxide mole number greater than 4 and up to 30. The composition may further comprise at least one of a) about 0.5% to about 1.5% w/w of a soluble seaweed extract in the aqueous solution, b) about 1.5% to about 2.5% w/w of soy protein hydrolysate amino acids in the aqueous solution, c) about 10% to about 20% w/w of combined nitrogen, phosphorus, potassium and sulfur in the aqueous solution, d) about 4% to about 7% w/w of combined chelated calcium, magnesium, microorganisms, humic acids, fulvic acids and carboxylic acids in the aqueous solution, and e) about 12% to about 16% w/w of combined potassium nitrate, calcium and soy protein hydrolysate amino acids in the aqueous solution.

A method for stimulating plant growth may comprise applying a composition to the plant that is formulated as a biostimulant for the plant growth, the composition comprising elemental iodine and potassium iodide in an aqueous solution at a weight ratio of about 1:1.2 to 1:5 and potassium iodate in the aqueous solution at a weight ratio of about 1:0.5 to 1:5 to the combined weight of the elemental iodine and potassium iodide. Ether-nonyl polyglycol ethoxylate may be in the aqueous solution at a weight ratio of about 3:1 to 20:1 to the combined weight of the elemental iodine and potassium iodide to emulsify the elemental iodine and enhance its stability. A first stabilizing agent may comprise salicylic acid in the aqueous solution at a weight ratio of about 1:0.2 to 1:10 to the elemental iodine, and a second stabilizing agent may comprise ascorbic acid in the aqueous solution in an amount to enhance solubility and bioavailability of iodine and impart to the aqueous solution a pH between about 4 and 6.

The method may include immersing a seed for about 4 to 12 hours within the aqueous solution as the composition before sowing the seed to grow into the plant. The method may include foliar spraying the composition onto the plant about every 5 to 10 days while the plant grows in a nursery, and in an example, foliar spraying about every 12 to 18 days the composition onto the plant transplanted from the nursery to a field.

A composition for modulating plant physiological processes may comprise elemental iodine (I₂) and iodide (I⁻) in an aqueous medium at a weight ratio from about 1:1.2 to about 1:5 and iodate (IO₃⁻) present in the aqueous medium at a weight ratio from about 1:0.5 to about 1:5 relative to the combined weight of elemental iodine and iodide. An organic reducing acid may comprise ascorbic acid or a derivative thereof and an organic physiological acid may comprise salicylic acid or a derivative thereof. At least one non-ionic, biodegradable surfactant may be included wherein the composition forms a redox-active iodine matrix that interconverts iodine species in the aqueous medium.

The non-ionic, biodegradable surfactant is present at a weight ratio from about 3:1 to about 20:1 relative to the combined weight of elemental iodine and iodide. The non-ionic, biodegradable surfactant may comprise an alkyl polyglucoside (APG). The organic reducing acid and the organic physiological acid may be present at a combined weight ratio relative to total iodine species from about 0.05:1 to about 10:1. The organic reducing acid may be present in an amount effective to regulate reversible oxidation-reduction interconversion between iodine species.

The aqueous medium may have a pH from about 3 to about 7 to support reversible iodine redox cycling. The iodine may be reversibly cycled among iodine species within the redox-active iodine matrix. The non-ionic, biodegradable surfactant may be present in a concentration to stabilize reactive iodine species while preserving redox functionality in the aqueous medium.

A method for modulating plant physiological responses may comprise applying a composition to a plant, seed, or plant growth medium. The composition may comprise elemental iodine (I₂) and iodide (I⁻) in an aqueous medium at a weight ratio from about 1:1.2 to about 1:5 and iodate (IO₃⁻) present in the aqueous medium at a weight ratio from about 1:0.5 to about 1:5 relative to the combined weight of elemental iodine and iodide. An organic reducing acid may comprise ascorbic acid or a derivative thereof and an organic physiological acid may comprise salicylic acid or a derivative thereof. At least one non-ionic, biodegradable surfactant may be included wherein the composition forms a redox-active iodine matrix that interconverts iodine species in the aqueous medium.

The method may comprise immersing a seed for about 4 to 12 hours within the aqueous solution as the composition before sowing the seed to grow into the plant. The method may comprise foliar spraying the composition onto the plant about every 5 to 10 days while the plant grows in a nursery. The method may include foliar spraying about every 12 to 18 days the composition onto the plant transplanted from the nursery to a field. The modulation may comprise enhanced nutrient assimilation, stress tolerance, metabolic efficiency, or growth regulation mediated by the redox-active iodine matrix.

### BRIEF DESCRIPTION OF THE DRAWINGS

Other objects, features and advantages of the present invention will become apparent from the Detailed Description of the invention which follows, when considered in light of the accompanying drawings in which:

FIG. 1 is a pie chart showing the global biostimulants market share by active ingredients for year 2021.

FIG. 2 is a chart showing an overview of the primary biological processes affected by iodine.

FIGS. 3A-3C are graphs, images, and charts showing the impact of iodine on plant growth.

FIG. 4 is a layout of the trial map used in testing the biostimulant compositions according to the invention.

FIG. 5 is a table of the production results and performance from the different tests of the example biostimulant compositions.

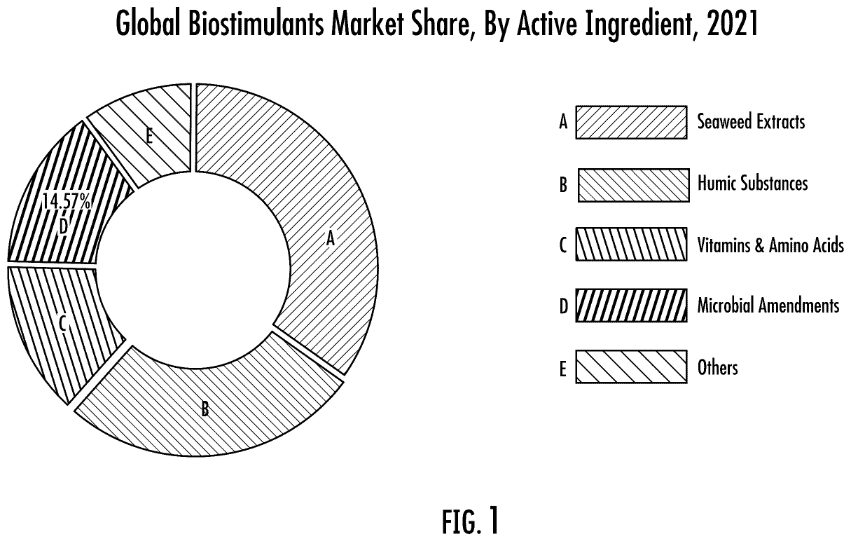

### DETAILED DESCRIPTION

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art.

In accordance with a non-limiting example, the plant assimilable biostimulant composition is capable of being absorbed by plant tissues possessing the desired effects and catalytic roles of iodine in plant physiology without the risk of causing phytotoxicity to plant tissue or toxicity to the natural environment fauna and beneficial microorganisms. These results may be accomplished in conjunction with other organic and inorganic plant fertilizer compounds. The biostimulant composition provides various biostimulation and fertilization enhancing benefits for plants and vegetation in agricultural crops. The term “vegetation” is intended to mean any plant, cane, vine, shrub, bush, tree or any vegetation in general.

Multiple prior art experiments and attempts have been made to find a satisfactory technique for effectively administering iodine to plants for the purpose of food biofortification in humans. Typical exogenous administration has been tried, but many known techniques and treatments have shown phytotoxic effects when iodine has been applied at high concentrations, especially in the I-form, which is more phytotoxic than iodate (IO3-). Some experiments may have found that more effective treatment is with KI (potassium iodide).

Iodine may be absorbed by plants from the soil via roots, through the air, or rain. It may also be dissolved and applied from saline solutions and applied from hydroponic systems via soil applications.

Iodine foliar application of iodine as potassium iodine on leaves of sweet pepper seedlings has been shown to improve nutrient uptake, improve the amount and activity of antioxidants and the vigor of seedlings. Iodine (in the range of 1-10 μM) may increase biomass in vegetables, e.g., spinach, lettuce, tomato, and strawberry, or staple crops, e.g., barley and wheat. Experiments on tomatoes demonstrated that treatments with iodine accelerated plant growth causing early flowering associated with an increase in yield. Iodine administration in micromolar concentrations has shown in recent studies a benefit in biomass accumulation and may promote early flowering.

Iodine is likely involved in several physiological and biochemical processes. The presence of low concentrations of iodine is often associated with beneficial effects on plant growth, production, stress resistance, and other relevant photosynthetic and enzymatic processes. Iodine is able to modulate gene expression in a specific way activating multiple pathways mostly involved in defense responses. This suggests that iodine may protect against both biotic and abiotic stress, and can be a structural component of several different proteins.

Iodine may also conserve iodinated proteins that are synthesized in both the roots and shoots of phylogenetically distant species. Analysis of proteomic data revealed that iodinated proteins identified in the shoots of plants are mainly associated with the chloroplast and are functionally involved in photosynthetic processes. The most representative biological processes affected by iodine in the roots were related to the response to stimulus, and the downstream categories associated with response to abiotic and biotic stimulus.

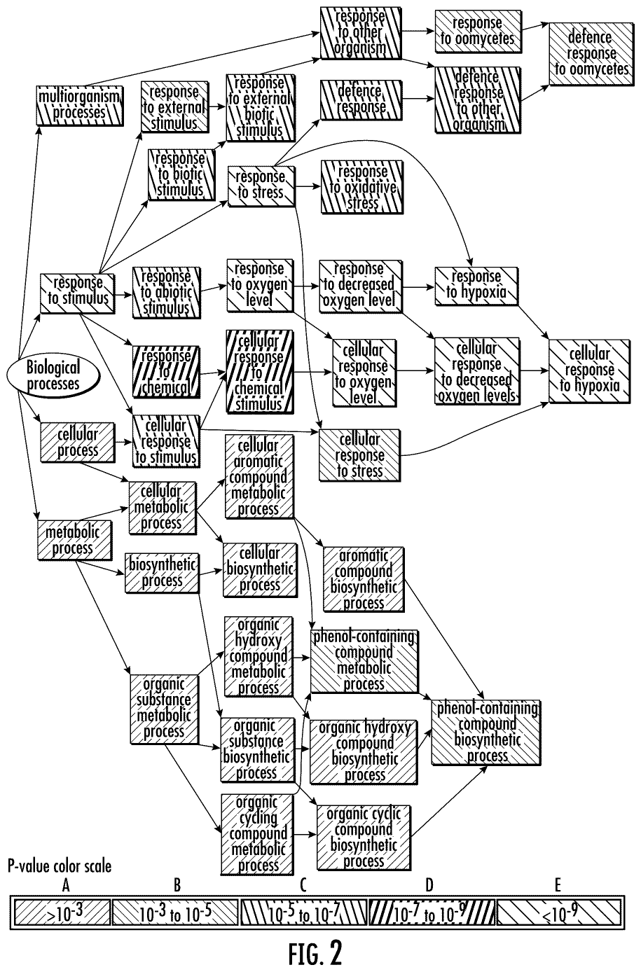

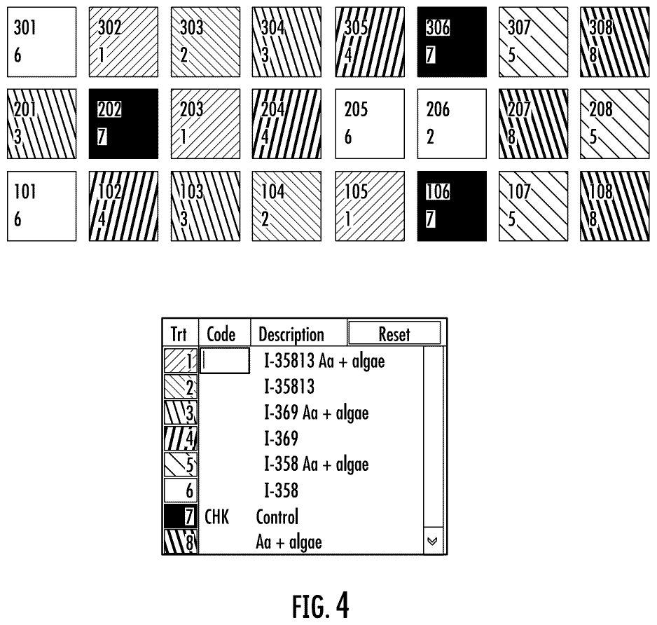

Reference is made to the article by Kiferle et al., “Evidences for a Nutritional Role of Iodine in Plants,” Frontiers in Plant Science, Volume 12, Article 616868, published Feb. 17, 2021, and FIGS. 2 and 4 from that article. FIG. 2 corresponds to FIG. 45 in Kiferle et al. and shows an overview of the main biological processes affected by iodine based upon the GO terms enrichment analysis carried out in root tissues. Only genes regulated in NaI- and KI-treated plants, and not in KBr-treated plants, when compared with the control, were analyzed. The figure was extracted from Gorilla (http://cbl-gorilla.cs.technion.ac.il. In this analysis, DEGs with log 2 FC 2.5 or log 2 FC≤−2.5 were used. The main molecular functions regulated by iodine in the roots were related to antioxidant and oxidoreductase activity and related child terms, in particular peroxidase activity and oxidoreductase activity, acting on peroxide as an acceptor.

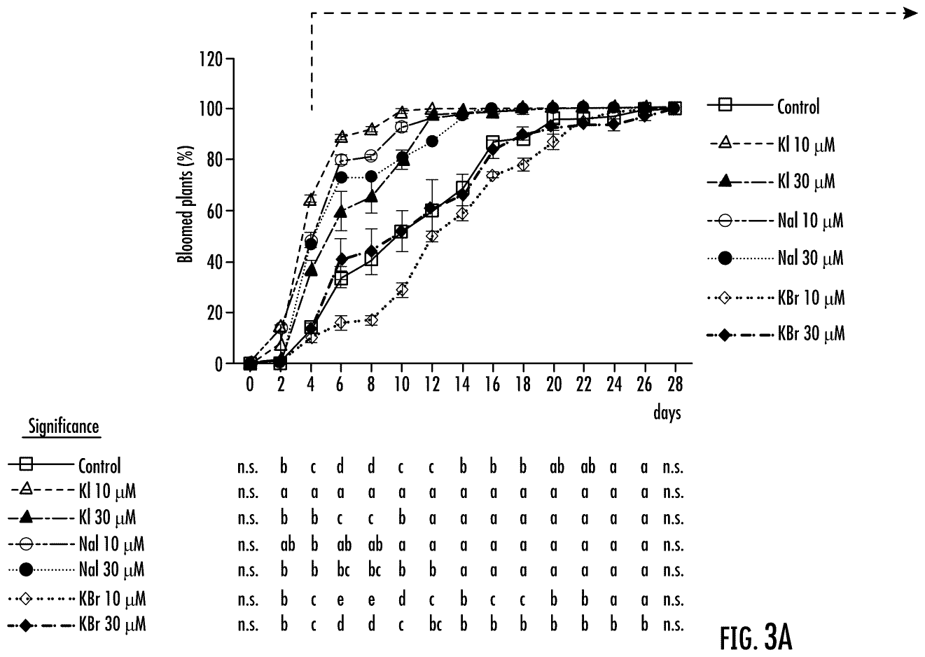

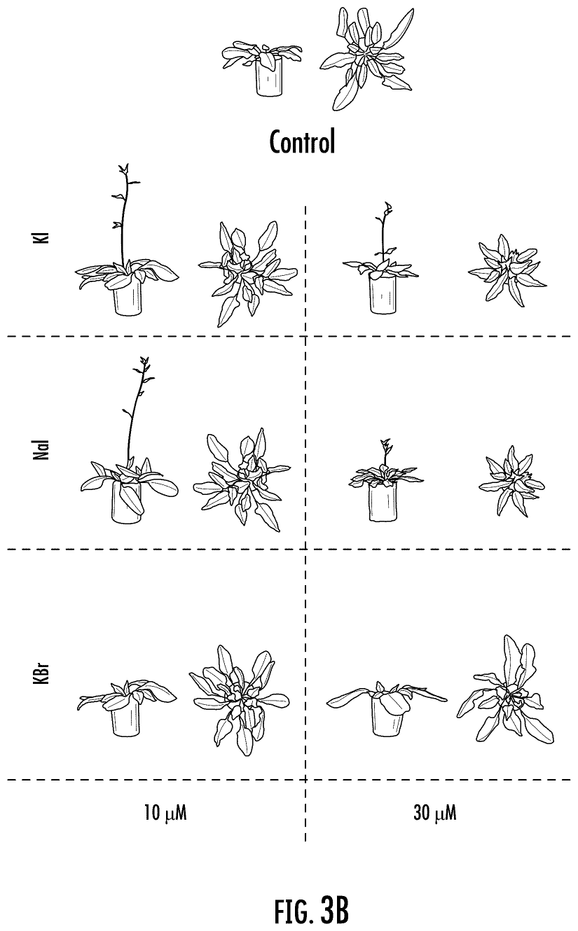

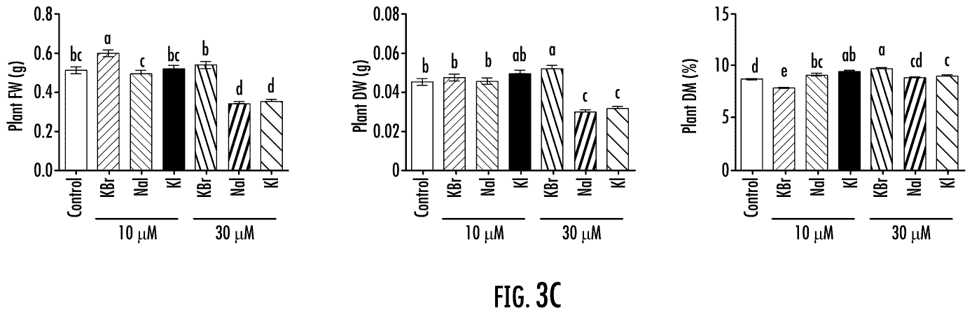

FIGS. 3A-3C correspond to FIGS. 2A-2C in Kiferle et al. and are graphs, images, and charts that show the impact of iodine on plant growth and development (exp. 2-phenotype). A flowering curve is shown in the graph of FIG. 3A, where the percentage of bloomed plants/tray was calculated every 2 days after the opening of the first flower (day 0). FIG. 3B are images showing a representative control and shows KI-, NaI- or KBr-treated plants (10 and 30 μM) after 15 days from the onset of the treatments. Images were taken after 4 days from the opening of the first flower on the main stem. FIG. 3C shows bar charts of the morphological data on plant FW, DW, and dry matter content that was determined 15 days after the onset of the treatments. The values indicated by different letters significantly differ from each other, in accordance with one-way ANOVA, LSD post hoc test, P≤0.05.

In particular, the statistical analysis of flowering as shown in FIG. 3A was performed by comparing the percentage of bloomed plants of each tray, which were considered as biological replicates within each sampling point. When data followed a normal distribution and there was homogeneity of variances, they were subjected to one-way ANOVA and values indicated by different letters significantly differ from each other (LSD post hoc test, P≤0.05). When one of these two prerequisites were violated, a Kruskal-Wallis test was performed. Error bars (±SE) are shown in the graphs. These results and previously cited data demonstrate the catalytic and metabolic role of iodine in plant nutrition and biostimulation.

The developed biostimulant composition, according to the invention, improves the function and effect over previous developments, and in accordance with a non-limiting example, is a plant assimilable biostimulant and biocatalyst that may be used as a plant growth regulator to increase biomass production, enhance photosynthetic processes, increase crop yield, and improve stress and defense/immune response in plants. The biostimulant composition may be used as an enhancing excipient for organic and inorganic plant-nutrient compound to formulate plant fertilizers that include amino acids, free amino acids, N-containing substances, N-fixing bacteria, carboxylic acids, animal and vegetal protein hydrolysates, yeast, peptides, silicon, phosphites, humic and fulvic acids, bone meal, fish meal, kelp meal or seaweed extract, phenolic compounds, chitin and chitosan derivatives, manure, microbial soil amendments and synthetic plant fertilizers, macro and micro plant-nutrient elements. In addition, the biostimulant composition with additives may be used as a treatment against Huanglongbing (HLB or Citrus Greening) “Candidatus Liberibacter asiaticus” or “Candidatus Liberibacter africanus,” and used for the prevention of B.E.R. (Blossom end Rot), a physiological disorder in tomato plants.

Non-limiting examples of the biostimulant composition are now described. The ranges as described may vary by up to 5% and sometimes 10% in some cases. In a first example, the composition may be formulated as a biostimulant for plant growth and may include elemental iodine and potassium iodide in an aqueous solution at a weight ratio about 1:1.2 to 1:5. Ether-nonyl polyglycol ethoxylate may be in the aqueous solution at a weight ratio of about 3:1 to 20:1 to the combined weight of the elemental iodine and potassium iodide. The ether-nonyl polyglycol ethoxylate may have an ethylene oxide mole number greater than 4 and up to 30.

In another example, the composition may be formulated as a biostimulant for plant growth and may include elemental iodine and potassium iodide in an aqueous solution at a weight ratio about 1:1.2 to 1:5. Potassium iodate may be in the aqueous solution at a weight ratio of about 1:0.5 to 1:5 to the combined weight of the elemental iodine and potassium iodide. As in the first example above, ether-nonyl polyglycol ethoxylate may be in the aqueous solution at a weight ratio of about 3:1 to 20:1 to the combined weight of the elemental iodine and potassium iodide. A first stabilizing agent as an acid, such as salicylic acid, may be in the aqueous solution at a weight ratio of 1:0.2 to 1:10 based on the elemental iodine added in an amount to enhance solubility and bioavailability of iodine in the aqueous solution.

A second stabilizing agent such as ascorbic acid may be added in an amount to enhance solubility and bioavailability of iodine in the aqueous solution and aid in imparting to the aqueous solution a pH value between about 4 and 6. The pH values may vary as noted below when describing different stabilizing agents, acids and surfactants. A surfactant may be added in an amount to aid in solubilizing and complexing iodine. For example, one or more of Nonylphenol Ethoxylates, Alcohol ethoxylates/alkoxylates, Sorbitan ester ethoxylates, Alkylpolyglucosides (APG), Polyvinylpyrrolidones (PVP), and Ethylene oxide-propylene oxide copolymers may be added as a surfactant. The weight ratio of the first stabilizing agent, such as the salicylic acid to the combined weight of the elemental iodine, the potassium iodide and potassium iodate may be about 0.1:1 to 0.5:1.

About 0.5% to about 1.5% w/w of a soluble seaweed extract may be added in the aqueous solution. In another example, about 1.5% to about 2.5% w/w of soy protein hydrolysate amino acids may be added in the aqueous solution. About 10% to about 20% w/w of combined nitrogen, phosphorus, potassium and sulfur may be added in the aqueous solution. About 4% to about 7% w/w of combined chelated calcium, magnesium, microorganisms, humic acids, fulvic acids and carboxylic acids may be added in the aqueous solution. About 12% to about 16% w/w of combined potassium nitrate, calcium and soy protein hydrolysate amino acids may be added in the aqueous solution.

When applying the composition as a biostimulant, it is possible to immerse a seed for 4 to 12 hours within the aqueous solution as the composition before potting or sowing the seed. Once the seed has sprouted, this can be followed by foliar spraying the composition onto the plant every 5 to 10 days while the plant grows in a nursery. From that point on, the composition may be foliar sprayed on plants transplanted from the nursery to a field every 12 to 18 days. The biostimulant composition has been found to dilute readily for different applications. Tests were performed and described below.

Three examples of the biostimulant composition were used in the testing, with general description as follows and given the designation I-369, I-358, and I-35813, with the designation “I” indicating the iodine based nature of the biostimulant composition.

I-369. The composition includes: (a) elemental iodine; (b) potassium iodide; (c) an ether-nonyl polyglycol ethoxylate having an ethylene oxide mole number greater than 4 and up to 30; and (d) an agriculturally accepted liquid carrier or diluent. The weight ratio of elemental iodine and potassium iodide is in the range of about 1:2. The weight ratio of ether-nonyl polyglycol ethoxylate to the combined weight of the elemental iodine and the potassium iodide may be about 3:1 to 20:1. In an example, the diluent is water. The composition may optionally include other organic and/or inorganic water-soluble plant-fertilizer compounds.

I-358. The composition includes: (a) elemental iodine; (b) potassium iodide; (c) potassium iodate; (d) an ether-nonyl polyglycol ethoxylate having an ethylene oxide mole number greater than 4 and up to 30; and (e) an agriculturally accepted liquid carrier or diluent. The weight ratio of elemental iodine and potassium iodide is in the range of about 1:2. The weight ratio of potassium iodate to the combined weight of the elemental iodine and the potassium iodide is about 2:1. The weight ratio of ether-nonyl polyglycol ethoxylate to the combined weight of the elemental iodine, the potassium iodide and the potassium iodate is about 3:1 to 20:1. The diluent may be water. The composition may include optionally other organic and/or inorganic water-soluble plant-fertilizer compounds.

I-35813. The composition includes: (a) elemental iodine; (b) potassium iodide; (c) potassium iodate; (d) salicylic acid; (e) an ether-nonyl polyglycol ethoxylate having an ethylene oxide mole number greater than 4 and up to 30; and (f) an agriculturally accepted liquid carrier or diluent. The weight ratio of elemental iodine and potassium iodide is in the range of about 1:2. The weight ratio of potassium iodate to the combined weight of the elemental iodine and the potassium iodide is about 2:1. The weight ratio of salicylic acid to the combined weight of the elemental iodine, the potassium iodide and the potassium iodate is about 0.1:1 to 0.5:1. The weight ratio of ether-nonyl polyglycol ethoxylate to the combined weight of the elemental iodine and the potassium iodide is about 3:1 to 20:1. The diluent may water. The composition may optionally include other organic and/or inorganic water-soluble plant-fertilizer compounds.

Also tested were amino acids and algae used together in combination as a reference and an untreated control was tested as a reference. Those tests were used to establish the improvement on the yield and quality. This biostimulant efficiency study was performed to ascertain the impact of the biostimulant compositions I-358, I-369 and I-35813 alone and in combination with algae and amino acids to tomato growth and yield.

OBJECTIVE: NEVAL GRUPO FARMALENT S.L C/Alfonso XIII, 3 12592, Chilches, Castellón, Spain performed the research study to test the efficiency of the three biostimulant compositions (I-369; I-358; and I-35813), alone and in combination with algae and amino acids to determine impact on the biomass and production of tomato, in Spain, in 2023. This study was performed in accordance with the protocol agreed upon with EPPO guidelines 152, 181 and 135, 225, 226 Good Experimental Practices and Following the internal Standard Operative Procedures.

EXPERIMENT: A randomized complete block design was used with three (3) replications per treatment (FIG. 4). Untreated plots were included. The schedule of applications followed the protocol being in seed imbibition, and then each 8 days in nursery, after transplanting each 15 days by foliar application. Plots were first in pots and then transplanted to the soil.

The soil type was measured as clay: 29% sand, 21% silt, and 50% clay. The trial on tomato, variety optima, was performed in Xilxes, Castellón, Spain in 2023. The trial was conducted under EPPO PP 1/135(4), PP 1/152(4), PP 1/181 (4), PP 1/296 (1). CEN/TS 17700-1:2022, CEN/TS 17700-4:2022. The crop development was normal and protocol was followed without any deviation. There were no problems when handling the products. The maintenance was similar throughout the Nursery Field.

The Nursery Field included pots with 12 centimeter one (1) plant/pot with Field Plots having a width of 1.2 meters and length of 1.32 meters, including three replicates. The Irrigation was 10 minutes per day with a drip system 2 L/H. The soil was clay with a fine texture group and Turf Thatch Rating—OFC, and Tillage Type CONVTIL. Soil drainage was poor and the previous crop was ALLSS. The CED units were 217.0 meq/100 grams with 29% sand, 21% silt and 50% clay, and pH of 7.9 with 2.2% organic matter and a 2% slope. Maintenance included Bacillus thuringiensis each 14 days. Weather was normal during the testing period. The treatment list is shown in the table below.

Treatment List

| | | Seed | Nursery | Transplanted |
|---|---|---|---|---|
| | | immersion | foliar | field |
| Treatment | Treatment | during | each | each |
| No. | Name | 4-12 h | 8 days | 15 days |
| 1 | I 35813 | 1 cc/L | 2 cc/L | 2 cc/L |
| | Aa + algae | | | |
| 2 | I 35813 | 1 cc/L | 2 cc/L | 3 cc/L |
| 3 | I 358 | 1 cc/L | 2 cc/L | 3 cc/L |
| 4 | I 358 | 1 cc/L | 2 cc/L | 2 cc/L |
| | Aa + algae | | | |
| 5 | I 369 | 1 cc/L | 2 cc/L | 3 cc/L |
| 6 | I 369 | 1 cc/L | 2 cc/L | 2 cc/L |
| | Aa + algae | | | |
| 7 | Control | — | — | — |
| 8 | Aa + algae | 1 cc/L | 2 cc/L | 2 cc/L |

APPLICATION SCHEDULE: The schedule carried
out during the trial was:

| | | |
|---|---|---|
| Seeds immersion | Nursery Foliar | In field Foliar |
| during 4-12 hrs | Spray each 8 days | Spray each 15 days |

| | |
|---|---|
| Immersion of the seeds | 27-June |
| Sowing | 28-June |
| App. A (nursery) | 12-July |
| App. B (nursery) | 20-July |
| App. C (nursery) | 28-July |
| TRANSPLANTING TO SOIL | 09-August |
| App. D | 17-August |
| App. E | 24-August |
| App. F | 01-September |
| App. G | 16-September |
| App. H | 01-October |
| App. I | 16-October |
| End of trial | 26-October |

The tested products as the three biostimulant compositions were compared with a combination of amino acids (TerraSorb) and Algae (Phylgreen).

The TERRASORB composition included free amino acids (*) 9.3% (w/w); Total Nitrogen (N) 2.1% (w/w); Organic Nitrogen (N) 2.1% (w/w); Boron (B) 0.02% (w/w); Manganese (Mn) 0.05% (w/w); Zinc (Zn) 0.07% (w/w); and Organic Matter 14.8% (w/w). (*) The formulation contains each and every one of the biologically active free amino acids: ASP, SER, GLU, GLY, HIS, ARG, THR, ALA, PRO, CIS, TYR, VAL, MET, LYS, ILE, LEU, PHE, TRP.

The PHYLGREEN composition may include 1.2% p/p (1.3% p/v) mannitol, 2% p/p (2.2% p/v) alginic acid, 100% p/p (110% p/v) seaweed extract Ascophyllum nodosum, dry matter (from seaweed extract): 15% w/w (16.5% w/v). The three biostimulant compositions (I-369, I-358, and I-35813) may be prepared using different techniques. A non-limiting example of the preparation of the three biostimulant compositions is explained below.

I-369: Step 1: Preparing the Iodine Solution. Dissolve elemental iodine (I₂) and potassium iodide (KI) in water at a weight ratio of elemental iodine to potassium iodide of 1:1.2 to 1:5. Maintain the temperature at no more than about 25° C. Stir the mixture for 5-15 minutes, preferably achieving a pH value between 4 and 6. Dilute the resulting mixture with 1 to 4 parts water or another agriculturally acceptable diluent.

Step 2: Preparing the Ether-Nonyl Polyglycol Ethoxylate Solution. Dissolve ether-nonyl polyglycol ethoxylate (with preferred ethylene oxide mole number greater than 4 and up to 30) in water. Use a ratio of not more than 1.25 parts (w/w) ether-nonyl polyglycol ethoxylate to 1 part (w/w) water. Maintain the temperature between 60° C. and 70° C. under agitation. Achieve a concentration of preferably 55% by weight of ether-nonyl polyglycol ethoxylate. Allow the solution to cool to a temperature of 20° C. to 25° C.

Step 3: Mixing the Solutions. Mix the resulting solutions from steps 1 and 2 under agitation. Ensure a weight ratio of the ether-nonyl polyglycol ethoxylate to the combined weight of the elemental iodine and potassium iodide of 3:1 to 20:1, preferably 6:1.

I-358: Step 1: Preparing the Iodine Solution. Dissolve elemental iodine (I₂) and potassium iodide (KI) in water at a weight ratio of elemental iodine to potassium iodide of 1:1.2 to 1:5. Add potassium iodate (KIO₃) at a weight ratio of 1:0.5 to 1:5 to the mixture. Maintain the temperature at no more than about 25° C. Stir the mixture for 5-15 minutes, preferably achieving a pH value between 4 and 6. Dilute the resulting mixture with 1 to 4 parts water or another agriculturally acceptable diluent.

Step 2: Preparing the Ether-Nonyl Polyglycol Ethoxylate Solution Dissolve ether-nonyl polyglycol ethoxylate (with an ethylene oxide mole number greater than 4 and up to 30) in water. Use a ratio of not more than 1.25 parts (w/w) ether-nonyl polyglycol ethoxylate to 1 part (w/w) water. Maintain the temperature between 60° C. and 70° C. under agitation. Achieve a concentration of preferably 55% by weight of ether-nonyl polyglycol ethoxylate. Allow the solution to cool to a temperature of 20° C. to 25° C.

Step 3: Mixing the Solutions. Mix the resulting solutions from steps 1 and 2 under agitation. Ensure a weight ratio of the ether-nonyl polyglycol ethoxylate to the combined weight of the elemental iodine and potassium iodide of 3:1 to 20:1, preferably 6:1.

I-35813: Step 1: Preparing the Iodine Solution. Dissolve elemental iodine (I₂) and potassium iodide (KI) in water at a weight ratio of elemental iodine to potassium iodide of 1:1.2 to 1:5. Add potassium iodate (KIO₃) at a weight ratio of 1:0.5 to 1:5 to the mixture. Maintain the temperature at no more than about 25° C. Stir the mixture for 5-15 minutes. Add ascorbic acid (C₆H₈O₆) to the mixture in a ratio of 1:0.2 to 1:10, preferably achieving a pH value between 4 and 6. Dilute the resulting mixture with 1 to 4 parts water or another agriculturally acceptable diluent.

Explanation: The reaction between potassium iodide (KI) and potassium iodate (KIO₃) in the presence of water produces iodine (I2) through the following reaction: 2KI+KIO3+3H2O→3I2+3KOH2KI+KIO₃+3H₂O→3I2+3KOH2KI+KIO3+3H2O→3I2+3KOH. The reaction between potassium iodide (KI) and potassium iodate (KIO₃) in the presence of water produces iodine (I2) through the following reaction: 2KI+KIO3+3H2O→3I2+3KOH2KI+KIO₃+3H₂O→3I₂+3KOH2KI+KIO3+3H2O→3I2+3KOH. Ascorbic acid (C₆H₈O₆) is added as a reducing agent to ensure the stability of the iodine solution and to help maintain the desired pH level, which enhances the solubility and availability of molecular iodine.

Step 2: Preparing the Ether-Nonyl Polyglycol Ethoxylate Solution. Dissolve ether-nonyl polyglycol ethoxylate (with an ethylene oxide mole number greater than 4 and up to 30) in water. Use a ratio of not more than 1.25 parts (w/w) ether-nonyl polyglycol ethoxylate to 1 part (w/w) water. Maintain the temperature between 60° C. and 70° C. under agitation. Achieve a concentration of preferably 55% by weight of ether-nonyl polyglycol ethoxylate. Add salicylic acid (C₇H₆O₃) to the solution in a ratio of 1:0.2 to 1:10 based on the elemental iodine. Allow the solution to cool to a temperature of 20° C. to 25° C.

Explanation: Ether-nonyl polyglycol ethoxylate may serve as a surfactant and may help emulsify the iodine and enhance its stability and effectiveness. The acid as the example Salicylic acid (C₇H₆O₃) increases molecular iodine uptake and may also have biostimulant properties.

Step 3: Mixing the Solutions. Mix the resulting solutions from steps 1 and 2 under agitation. Ensure a weight ratio of the ether-nonyl polyglycol ethoxylate to the combined weight of the elemental iodine and potassium iodide of 3:1 to 20:1, preferably 6:1.

Explanation: Mixing these solutions may ensure the formation of a stable and effective iodine formulation. The presence of the surfactants (ether-nonyl polyglycol ethoxylate) and the stabilizing agents (ascorbic acid/organic acids as buffers or buffering acids) may help to maintain the availability of molecular iodine (I₂) in the solution.

Additional Information on Surfactants: There are a variety of surfactants that can be used to solubilize and complex iodine, including: Nonylphenol ethoxylates; Alcohol ethoxylates/alkoxylates; Sorbitan ester ethoxylates; Alkylpolyglucosides (APG); Polyvinylpyrrolidones (PVP); Ethylene oxide-propylene oxide copolymers. When choosing a complexing surfactant, areas of consideration are: selecting a surfactant that provides effective iodine stability; and ensuring the surfactant is compatible with the intended agricultural or industrial application.

Benefits: Stability: The combination of potassium iodide, potassium iodate, and stabilizing agents, such as ascorbic acid and other organic acids, ensure the stable formation and maintenance of molecular iodine (I₂).

Effectiveness: The use of surfactants and salicylic acid stabilizers enhances the solubility and bioavailability of iodine, making it more effective for agricultural applications.

Biostimulant Properties: The resulting composition as a solution has been found to act as a plant biostimulant and biocatalyst, promoting plant growth and acting as a fertilizing compound. Field research has shown that this biostimulant composition, with its added components, functions effectively as a plant biostimulant and biocatalyst, aiding in the growth and health of plants. The formulation's effectiveness can vary slightly with changes in component ratios, but it remains a robust solution for agricultural use.

Different Organic/Inorganic Acids May be Used. The term “buffer” or “buffering acid” may be used to describe any compatible inorganic or organic acid which is capable of maintaining a pH of compositions within the range of about 1.0 to about 6.5, about 1.5 to about 6.5, about 2.0 to about 5.5, about 2.0 to about 5.0, about 1.0 to about 3.5 to 4.0 in an example with a range of about 2.0 to about 4.0 preferred in some applications. The pH of the composition may vary based upon the end use regimen. It is possible to generate molecular iodine more quickly after admixing the actives using a pH range of pH 2 to pH 4, with a preferred pH range of pH 2 to pH 3.

If the composition will be activated but not used immediately, but rather used after a delay, then a preferred pH range may be up to 6.5. Different acids may be used, which include mono or polyacids that provide a buffering effect to maintain the pH of the biostimulant composition. Acidic entities such as phosphate acids may be used, including polyphosphate acids, e.g., phosphoric acid and its related salts sodium dihydrogen phosphate and sodium mono-hydrogen phosphate, polyphosphoric acid (Hn+2PnO3n+1), organic acids having from two (2) to 20 or more carbon atoms, including acids according to the chemical structure R—CO2H, where R is an optionally substituted (often with one or more hydroxyl groups) C1-C20 alkyl, alkenyl, alkynyl, aryl or other carbon containing group optionally having more than one double bond, preferably C1-C10 or organic acids or organic acids containing more than one carboxylic acid moiety (polycarboxlic acids) such as citric acid, oxalic acid, succinic acid, fumaric acid, malonic acid, maleic acid and various sulphonic acids according to the chemical structure R1-SO3H, where R1 is a C1-C20 alkyl or aryl group which may be optionally substituted.

Organic acids may include, for example, citric, fumaric, glycolic, lactic, malic, tartaric, acetic, formic, oxalic acid, propanoic, propandioic, butanoic, butanedioic, pentanoic (valeric), pentandioic, hexanoic, hexandioic and benzoic, among others. Other acids which also may be used, for example, acids of bisulfate (sodium, potassium bisulfate), sulfamic acid, and ethylenediaminetetraacetic acid, among others. The use of citric acid, phosphoric acid or other polyacids may accommodate a number of hydrogen ions in a single chemical entity, which may assist in maintaining the pH of compositions within a relatively narrow buffered range, thus maintaining activity and stability. Citric acid may refer to the free acid or monobasic (e.g., sodium salt) form of 2-hydroxypropane-1,2,3-tricarboxylic acid acid (CAS Registry Number: 77-92-9). It is possible that the composition may incorporate the di- and tribasic forms of citric acid provided there is an effective amount of the free acid so that the pH of the composition lies within a range from about 1.5 to about 6.5, about 2.0 to 5.5, or about 2.0 to about 5.0.

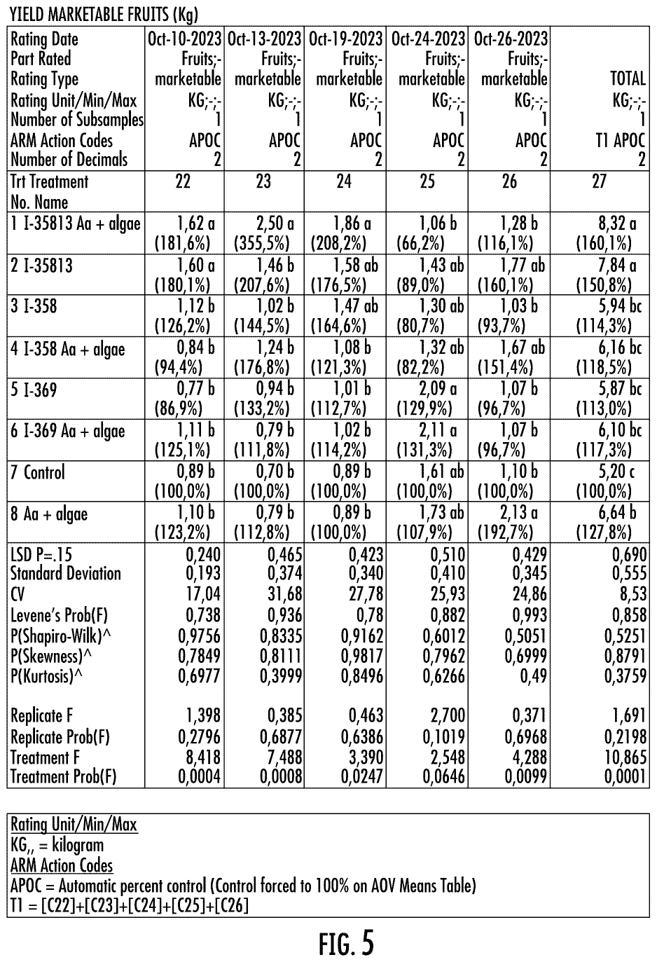

YIELD RESULTS: In the table of FIG. 5, the production results for various treatments are presented, and the analysis indicates the performance of each treatment compared to the control. The selectivity was assessed following EPPO guideline PP 1/135(4). No symptoms of Phytotoxicity were shown in comparison with the untreated control.

The statistical analysis of raw data was made according to EPPO guideline number PP 1/152 (4). Analysis of Variance (ANOVA) and a Bartlett test (homogeneity of the treatment variances) were performed on each assessment including/excluding the untreated to identify differences between treatments. Data failing to satisfy Bartlett's criteria for proof of homogeneity was subjected to a transformation (normally Arcsine sq. root, Log or Square root) when this improved the value. For means comparison, the LSD mean comparison test was used (P=0.15). The references in the text to statistical differences between treatments corresponded to Tukey's Test output (mean comparison letters) on the raw data, or on the transformed values in case data needed transformation to satisfy homogeneity of variance. The statistical procedures were applied using ARM 2023.0 software.

### Treatment Test Results and Performance:

I-35813 plus the amino acids (Aa) and algae: This treatment achieved the highest production, with an increase of 160.1% compared to the control. It consistently outperformed other treatments in each rating date. Notably, Aa+algae, recognized in the European market for biostimulation, demonstrated compatibility, and the presence of I-35813 further enhanced their expression.

I-35813: This treatment, when applied alone, showed a 150.8% increase in production compared to the control. The compatibility and synergy observed when combined with the Aa and algae highlight the positive influence of I-35813.

I-358: This treatment resulted in a 114.3% increase in production. The iodinated nature of the composition, especially I-35813 composition, emphasizes the significant biostimulating effects.

I-358 and the amino acids (Aa) and algae: The combination of I-358 and the amino acids and algae yielded a 118.5% increase. The compatibility and enhancement observed in this treatment support the effectiveness of the iodinated biostimulant composition in conjunction with the organic components.

I-369: This treatment resulted in a 113.0% increase in production compared to the 100% control.

I-369 and the amino acids (Aa) and algae: The combination of I-369 and the amino acids and algae led to a 117.3% increase compared to the 100% control.

Control: The control group had a production level of 100%.

Statistical Analysis: The LSD (Least Significant Difference) values indicate the minimum difference needed to consider two means significantly different. All treatments show significant differences compared to the control. Standard Deviation (SD) and Coefficient of Variation (CV) provide insights into data variability, with higher CV indicating greater variability. Levene's Prob(F) assesses homogeneity of variances, and the values suggest reasonable homogeneity. Shapiro-Wilk and Skewness tests assess normality and skewness of data, indicating that the assumptions for ANOVA are reasonably met. Kurtosis and Replicate F values also contribute to the assessment of data distribution and homogeneity.

Conclusion: The trial on tomato, Variety Optima, was performed in Xilxes, Castellón, Spain. A randomized complete block design was used with 3 replications per treatment. Untreated plots were included. The schedule of the biostimulant composition applications followed the protocol for seed imbibition. Application occurs then each 8 days while growing plants are in nursery. After transplanting to the field, application occurs each 15 days by foliar application.

The tested products were compared with their combination of amino acids (TerraSorb) and Algae (Phylgreen) and without the addition of these two products. Also tested were the amino acids and algae as a reference, and an untreated control, in order to know the improvement on the yield and quality, in Spain in 2023.

There were no phytotoxicity symptoms throughout the trial. The total marketable yield had significant differences. Statistically, the best of all the tested products was the I-35813 composition with 8.32 kg in 10 marked plants as shown in the last column of FIG. 5 in the row marked I-35813 Aa+algae.

The combination of the amino acids and algae had the second highest result with 6.64 kg in 10 marked plants. The products I-358 and I-369 with and without the combination had no significant differences between them with a yield between 5.87 to 6.16 kg/10 plants and finally the control untreated with 5.20 kg/10 plants was the lowest.

The precocity was observed in the I-35813 composition with and without its combination with algae and amino acids, showing more yield in the first harvest. Non-commercial or non-marketable products were observed during the study, but due to the attack of insects (Thrips, Spodoptera), there were not observed symptoms of deficiencies during the study.

According to the SPAD and nitrogen on leaves, there were no significant differences between treatments. According to the length of the stem in centimeters, the product I-35813 appeared to increase the length of the aerial part. This is not as important because it depends also of the pruning in the crop, but in general they had more biomass. The results from the testing show that all three biostimulant compositions, particularly I-35813, significantly increased plant production, both individually and in combination with amino acids and algae.

I-35813 in combination with the amino acids (Aa) and algae showed the highest efficacy, surpassing other treatments and surpassing the control by a considerable margin. The compatibility and synergy observed with its combination with the amino acids and algae highlight the potential for integrated and enhanced biostimulation strategies in agriculture.

The statistical analysis supports the observed differences in treatments, reinforcing the reliability of the findings. The iodinated nature of these composition, especially I-35813, underscores the substantial biostimulating effects of the iodine-based biostimulant compositions, presenting a viable option for increasing yields in tomato plants. This suggests the potential application of the innovative biostimulation approach using the biostimulant compositions in optimizing agricultural productivity and contributing to sustainable crop management practices.

SELECTIVITY RESULTS: Phytotoxicity symptoms were not observed. The development of the plants was normal and spots or other alterations on the leaves or fruits were not observed.

EFFECTS ON NON-TARGET INDIVIDUALS: Other effects, positive or negative, on the incidence of other pests were not observed.

It has been found through field research as explained below that the biostimulant composition may include added components that aid function as a plant biostimulant and biocatalyst formulation, for example, plant fertilizing compounds. In these examples, the amounts may vary by as much as 5% to 10% above and below those stated values.

### Example 1

### Use of Biostimulant Composition as Active Ingredient with Other Components for Plant Biostimulant Formulations

It is shown that the biostimulant composition is useful as a biostimulant, i.e., plant growth regulator, to increase biomass production, crop yield and improve stress response and immune response in plants. In this first example, seaweed extract and other components, such as amino acids, may be added to the biostimulant composition, such as I-35813, to form a biostimulant formulation.

1. Dissolve soluble seaweed extract and soy protein hydrolysate amino acids in water at a ratio 1:2 under agitation. Let the resulting solution be at room temperature no higher or lower than 20 to 30° C. For the seaweed extract and amino acids, the TerraSorb and Phylgreen examples above may be employed.

2. Mix the resulting solution of step (1) and indicated amount of the biostimulant composition (C) under agitation.

TABLE 1
w/w % for Example 1
Plant Biostimulant Formulation

| | |
|---|---|
| Seaweed extract | 1.00000% |
| Soy Protein Hydrolysate Amino Acids | 2.00000% |
| Biostimulant Composition (C) | 93.0000% |
| Water | 4.00000% |

### Example 2

### Use of Biostimulant Composition with Other Components as Excipient for Plant Fertilizer Formulations

1. Dissolve soluble-nutrients and micronutrients in water at a ratio of 1:2 under agitation. Let the resulting solution be at room temperature no higher or lower than 20 to 30° C.

2. Mix the resulting solution of step (1) and indicated amount of the biostimulant composition (C) under agitation.

TABLE 2
w/w % for Example 2
Plant Fertilizer Formulation

| | |
|---|---|
| Nitrogen | 6.80000% |
| Phosphorus | 4.00000% |
| Potassium | 4.60000% |
| Magnesium | 0.00675% |
| Sulfur | 1.06000% |
| Zinc | 0.00600% |
| Boron | 0.00225% |
| Iron | 0.00120% |
| Copper | 0.01574% |
| Manganese | 0.00675% |
| Molybdenum | 0.00036% |
| Biostimulant Composition (C) | 67.20040% |
| Water | 16.49980% |

### Example 3

### Use of Biostimulant Composition with Other Components as Bactericidal Treatment Against HLB Citrus Greening

The biostimulant composition can be used with other components as a formulation to combat Huanglongbing (HLB or Citrus Greening) “Candidatus Liberibacter asiaticus” or “Candidatus Liberibacter africanus” in several citrus varieties and can be effective to bring trees back into a standard productive capacity and alleviate the harm caused by the disease.

1. Dissolve soluble potassium nitrate, chelated calcium, and soy protein hydrolysate amino acids in water at a ratio of about 1:2 under agitation. Let the resulting solution be at room temperature no higher or lower than 20-30° C.

2. Mix the resulting solution of step (1) and indicated amount of the biostimulant composition (C) under agitation.

TABLE 3
w/w % for Example 3

| | |
|---|---|
| Potassium Nitrate | 10.00000% |
| Calcium | 2.00000% |
| Soy Protein Hydrolysate Amino Acids | 2.00000% |
| Biostimulant Composition (C) | 72.00000% |
| Water | 14.00000% |

Experimental field test on Valencia Oranges: Approximately 5 acres of citrus trees (Valencia Oranges) infected with Huanglongbing (HLB or Citrus Greening) “Candidatus Liberibacter asiaticus” or “Candidatus Liberibacter africanus” located in Honduras, Central America, were treated with the above 5% (v/v) solution of the bactericidal treatment formulation that included the biostimulant composition, consisting of 11 applications total in a period of eight months. A secondary field of 5 acres of citrus trees infected with HLB were left untreated as a control.

Behavior:
a) 15 to 45 days after the beginning of the treatment damaged leaves started to fall off;
b) 30 to 45 days after the beginning of the treatment signs of new plant tissue emerged;
c) 30 to 45 days after the beginning of the treatment healthy vegetative shoots were forming;
d) 45 to 60 days after the beginning of the treatment trees presented a richer, deeper green color with new leaf mass and larger leaf area;
e) 60 to 90 days after the beginning of the treatment healthy bloom was present with less purging; and
f) 90 to 240 days after the beginning of the treatment the trees became productive with signs of normalized physiological processes.

In contrast, the untreated citrus trees remained infected and damaged.

Experimental field test on Persian Lime: Approximately 5 acres of citrus trees (Persian Lime) infected with Huanglongbing (HLB or Citrus Greening) “Candidatus Liberibacter asiaticus” or “Candidatus Liberibacter africanus” located in Honduras, Central America, were treated with the above 5% (v/v) solution of the bactericidal treatment formulation that included the base Iodophor composition, consisting of 11 applications total in a period of six months. A secondary field of 5 acres of citrus trees infected with HLB were left untreated as a control.

Behavior:
a) 15 to 45 days after the beginning of the treatment damaged leaves started to fall off;
b) 30 to 45 days after the beginning of the treatment signs of new plant tissue emerged;
c) 30 to 45 days after the beginning of the treatment healthy vegetative shoots were forming;
d) 45 to 60 days after the beginning of the treatment trees presented a richer, deeper green color with new leaf mass and larger leaf area;
e) 60 to 90 days after the beginning of the treatment healthy bloom was present with less purging; and
f) 90 to 180 days after the beginning of the treatment the trees became productive with signs of normalized physiological processes.

In contrast, the untreated citrus trees remained infected and damaged.

### Example 4

Use of Biostimulant Composition with Other Components as Soil Amendment Fertilizer Formulation

The biostimulant composition may be mixed with other components and used as a soil amendment for irrigation systems on fields, greenhouses or plantations.

1. Dissolve chelated calcium, magnesium, microorganisms, humic acids, fulvic acids, and carboxylic acids in water at a ratio of 1:2 under agitation. Let the resulting solution be at room temperature no higher or lower than 20 to 30° C.

2. Mix the resulting solution of step (1) and indicated amount of the biostimulant composition (C) under agitation.

TABLE 4
w/w % for Example 4
Soil Fertilizer Formulation

| | |
|---|---|
| Calcium | 1.0000% |
| Magnesium | 0.0500% |
| Microorganisms | 1.0000% |
| Humic Acids | 2.0000% |
| Fulvic Acids | 1.0000% |
| Carboxylic Acids | 1.0000% |
| Biostimulant Composition (C) | 87.90000% |
| Water | 6.05000% |

The composition as described above and in the experiments may be characterized as a stabilized non-ionic surfactant-iodine-salicylic acid complex with controlled release properties. As noted from details in the description, it is possible to form the composition as an iodine-redox precursor, followed by the controlled integration of a surfactant-organic acid phase, ensuring optimal complexation and stability.

Different non-ionic complexing surfactants may be used in the composition, which in an example may be formed as a redox-active iodine matrix composition that converts iodine species in an aqueous medium, such as water. Examples include alkyl polyglycosides such as glucopon, linear alcohol ethoxylates, alkylphenol ethoxylates and arkopals that may include nonylphenol polyethylene glycol ethers. The alkyl polyglycosides may be long chain, medium chain, caustic stable, short chain, and in an example, derived from fatty acids having C8-C16 alkyl chains and glucose units. These complexing, non-ionic surfactants help stabilize the iodine species and facilitate controlled release in agricultural applications. The complexing surfactants may have a beneficial or synergistic effect with iodine and salicylic acid, resulting in enhanced stability, controlled release, and improved bioavailability.

The surfactants as used in the redox-active iodine matrix composition generally offer a more sustainable and environmentally friendly alternative for plants, compared to other non-ionic surfactants. Some may be used in concentrations ranging from 5% to 20% by weight (p/p) in the composition, for example, an aqueous solution or formulation or medium. For example, an alkyl polyglycoside with hydroxyl (—OH) functional groups that interact with iodine species via hydrogen bonding and van der Waals forces may be used as a non-ionic complexing surfactant. The polyiodide anions (I₃⁻) may form weak interactions with the non-ionic hydrophilic regions of some non-ionic complexing surfactants, stabilizing the iodine in solution and preventing volatilization. If the surfactant contains a hydrophobic alkyl chain, it may enhance solubility in aqueous environments while allowing controlled iodine release when applied to plant surfaces.

The non-covalent interactions, such as hydrogen bonding and van der Waals forces as noted above, are beneficial. Unlike covalent bonds, which may form a more rigid structure, non-covalent interactions may allow the iodine complex to remain more dynamic and accessible to plant tissues. This flexibility may improve the uptake of iodine by plants and may allow for better control over its release, ultimately increasing the bioavailability and efficacy of the treatment. These non-covalent bonds may facilitate a more efficient and controlled interaction with plant surfaces, ensuring that iodine is delivered when and where it is needed most.

The stabilized iodine complex of the present composition may be formed through a series of well-defined chemical interactions using an iodine redox equilibrium. For example, elemental iodine (I₂) may react with iodide (I⁻) and iodate (IO₃⁻) to generate polyiodide species that enhance iodine solubility: Elemental Iodine (I₂)+Iodide (I⁻)→Polyiodide (I₃⁻) Iodine (I₂)+Iodate (IO₃⁻)→Polyiodide (I₄⁻).

Ascorbic acid (C₆H₈O₆) may serve as a reducing agent, partially converting iodine to iodide, thus stabilizing the redox equilibrium and preventing excessive oxidation. Iodine (I₂) may be reduced by ascorbic acid to form iodide (I⁻), while ascorbic acid may be oxidized to dehydroascorbic acid (C₆H₆O₆): Iodine (I₂)+Ascorbic Acid (C₆H₈O₆)→Iodide (I⁻)+Dehydroascorbic Acid (C₆H₆O₆). This reaction may help regulate the redox balance and prevent excessive oxidation, stabilizing the iodine precursor and producing a more effective composition.

There may also be a synergistic interaction with salicylic acid (C₇H₆O₃), which possesses both hydroxyl (—OH) and carboxyl (—COOH) groups. These groups contribute to iodine stabilization by chelating iodine species: Salicylic Acid (C₇H₆O₃)+I₃⁻→Chelation and stabilization of iodine. The presence of the salicylic acid may improve the penetration of the iodine complex into plant tissues, enhancing its bioavailability and increasing its effectiveness in plant defense responses.

A process may be employed for forming the redox-active, iodine matrix composition by forming an iodine redox precursor with the elemental iodine (I₂) serving as a base reference component. Potassium iodide and potassium iodate salts may be added at the ratios such as described above. Ascorbic acid (C₆H₈O₆) may be introduced at a ratio as described relative to iodine and other components to regulate redox balance, reduce excess iodine to an equilibrium state and stabilize the iodine precursor.

The redox-active iodine matrix composition may also be formed by preparing the surfactant-salicylic acid matrix where salicylic acid (C₇H₆O₃) is added to the aqueous solution or mixture in an amount sufficient to meet the ratio as described above. The solution is maintained at a controlled temperature of about 50 60° C. under mild agitation until a homogeneous phase is achieved. There is also the controlled complexation where the iodine-redox precursor solution is slowly added, such as dropwise, into the surfactant-salicylic acid matrix under continuous stirring. The slow addition may enhance complexation by allowing gradual interaction between the iodine species and any hydroxyl/carboxyl functional groups of the surfactant and salicylic acid. The final mixture stabilizes, resulting in a structured non-ionic surfactant-iodine-salicylic acid complex with enhanced stability and controlled release properties.

The composition that is denoted I-35813 above has been found beneficial as noted from the comparative experimental test results for the different compositions. This composition shows the superior performance as set out in the data and achieves high plant growth, health and production. The composition may include added amino acids (Aa) and algae and achieve a high production with an increase of 160.1% compared to the control, while consistently outperforming other treatments as noted above from the experimental results. Even applied alone, the composition facilitates 150.8% increase in production compared to the control.

The complexing surfactants may be non-ionic surfactants as they do not produce ions in a solution and are known to bond to ions, e.g., metal ions. Thus, they may be non-ionic due to the lack of charge. The redox-active iodine matrix composition may achieve superior results as noted in the experimental test trials described above and shown in the drawings, even with use of lower iodine concentrations of about 20 ppm, compared to some prior art iodine formulations requiring between 45-75 ppm without even the beneficial results obtained from the current redox-active iodine matrix composition. These successful test results demonstrate the enhanced bioavailability and efficiency of the composition. The experimental results show significant improvements in yield and quality of crops treated with the composition, outperforming traditional formulations. For example, tomato plants treated with the current redox-active iodine matrix composition showed a 160.1% increase in yield compared to the control.

A further advantage relates to the sequential redox reaction during the processing and preparation of the redox-active iodine matrix composition involving elemental iodine, potassium iodide, potassium iodate, ascorbic acid and salicylic acid. This combination significantly enhances the stability, bioavailability and efficacy of the iodine complex. There may also be a synergistic interaction between the redox-controlled iodine precursor and salicylic acid.

The redox-active iodine matrix composition may successfully achieve iodine stabilization and controlled release in agricultural applications. By integrating the redox-controlled iodine precursor with a surfactant-salicylic acid matrix under controlled conditions, the resulting composition as a matrix or complex may offer superior performance in plant uptake and microbial control. The composition may be structured for industrial scalability, offering a much improved alternative to existing iodine-based agricultural treatments, while ensuring greater sustainability through the use of the surfactant.

The benefits of the redox-active iodine matrix composition are evident in the positive test results for the I-35813 composition. Moreover, the use of non-covalent interactions in the composition complex enhances the uptake of iodine by plants, facilitating more efficient and effective agricultural applications. Advantageously, the composition promotes growth, stress tolerance and antimicrobial activity and the lower iodine concentration required for efficacy reduces the environmental impact and potential toxicity associated with higher iodine concentrations.

There now follows greater details of the redox-active iodine matrix composition and associated method for plant physiological modulation and support. The redox-active iodine matrix is capable of dynamically interconverting iodine species and modulating plant physiological responses as a functional redox system. The composition includes multiple iodine species such as elemental iodine (I₂), iodide (I⁻), and iodate (IO₃⁻), and an organic reducing acid (ascorbic acid/ascorbate), an organic physiological acid (salicylic acid), with a controlled pH range (4-6). The composition includes non-ionic surfactants for stabilization and complexation. These components form a dynamic oxidation-reduction matrix and more than a static iodine formulation.

The redox behavior is inherent in the initial description above because I₂/I⁻/IO₃⁻ are redox-linked species and ascorbic acid is a well-known iodine reducing agent. The pH control that imparted from the ascorbic acid and other components directly influences iodine redox equilibria. The non-ionic surfactants help stabilize reactive iodine species in solution. The redox-active iodine matrix composition is clearly distinguished from iodate-only or single-species iodine products and imparts stress modulation, signaling, nutritional iodine delivery, and other benefits. The composition avoids confinement to a single agronomic use (biostimulation).

The redox-active iodine matrix composition is supported by the experimental data described above. The physiological modulation and yield enhancement are consistent with redox-mediated iodine behavior. The elemental iodine and potassium iodide may be in an aqueous solution or medium at a weight ratio of about 1:1.2 to 1:5 and help establish a reduced iodine species pool. The potassium iodate may be in the aqueous solution at a weight ratio of about 1:0.5 to 1:5 relative to the combined weight of the elemental iodine and potassium iodide and helps establish an oxidized iodine species pool. The organic reducing acid may be ascorbic acid and may be present in an amount effective to regulate interconversion between iodine species and maintain a dynamic redox equilibrium. These ratios above and used herein may vary by up to 5% in value for each of the numbers.

The non-ionic stabilizing surfactant may be formed as ether-nonyl polyglycol ethoxylate and present at a weight ratio of about 3:1 to 20:1 relative to the combined weight of elemental iodine and potassium iodide. The surfactant helps stabilize the redox-active iodine matrix in aqueous solution. The organic physiological acid may include salicylic acid that is present in an amount effective to modulate plant physiological signaling while contributing to stabilization of the redox-active iodine matrix composition. The organic reducing acid and the organic physiological acid may cooperate to maintain reversible oxidation-reduction cycling of iodine species in the aqueous solution.

The redox-active iodine matrix composition helps modulate physiological processes in plants and goes beyond functioning as a plant growth regulator and provides a redox-responsive iodine environment that supports endogenous plant physiological processes without overriding hormonal control mechanisms. The aqueous medium for the composition may include multiple iodine species, organic acids, and non-ionic surfactants that together form a dynamic redox matrix capable of reversible iodine interconversion and physiological signaling modulation.

Conventional iodine-based agricultural products typically deliver iodine in a static chemical form, most commonly iodate or iodide as a single species. These formulations rely on passive uptake and reduction by the plant and do not provide control over iodine speciation, redox balance, or signaling behavior. The prior art iodine products present several limitations, e.g., 1) iodine is supplied in a fixed oxidation state; 2) redox interconversion is left entirely to plant metabolism; 3) physiological signaling effects are indirect and energetically costly; and 4) iodine bioactivity is limited by solubility and chemical rigidity.

The redox-active iodine matrix composition takes advantage of iodine's hypervalency and its wide range of oxidation states, commonly ranging from −1 to +7, due to its seven valence electrons and large atomic size. The most common oxidation states are −1 (in Iodide, I⁻), +1 (in Hypoiodite, IO⁻), +3 (in Iodite, IO₂⁻), +5 (in Iodate, IO₃⁻), and +7 (in Periodate, IO₄⁻) with a 0 oxidation state (in elemental iodine, I₂). With a −1 oxidation state for iodide, I⁻, it is a strong reducing agent and with a higher oxidation state for iodate (IO₃⁻) with its +5 oxidation state, it is a strong oxidizing agent.

The new redox-active iodine matrix composition as described operates as an iodine-based system that provides iodine in multiple redox-linked species, actively participates in redox cycling rather than remaining chemically static, such as only one oxidation state, modulates physiological responses without imposing a fixed biochemical pathway, and preserves iodine stability while maintaining redox functionality.

The redox-active iodine matrix composition provides a redox-active iodine matrix, rather than a conventional one-state iodine composition. The redox-active iodine matrix composition may be formed by the functional cooperation of multiple iodine species (I₂, I⁻, IO₃—), an organic reducing acid, and an organic physiological acid, together with a non-ionic, biodegradable surfactant in a controlled aqueous environment. These components collectively establish a dynamic oxidation-reduction matrix composition where iodine is reversibly interconverted among oxidation states in response to local redox conditions. Importantly, iodine is not maintained in a fixed oxidation state, but remains chemically responsive within the matrix with the aqueous solution or medium, allowing an iodine species and redox interconversion. Elemental iodine (I₂), iodide (I⁻), and iodate (IO₃—) are redox-linked species. Within the redox-active iodine matrix compositions, iodate (IO₃⁻) provides an oxidized iodine reservoir, iodide (I⁻) provides a reduced iodine reservoir, and elemental iodine (I₂) acts as a transient, biologically active intermediate.

The presence of these components in controlled proportions as described enables reversible interconversion governed by redox chemistry rather than forced chemical stabilization. The organic reducing acid, such as ascorbic acid or its derivatives, serves to regulate iodine redox interconversion, prevent irreversible oxidation or depletion of iodine species, and support dynamic redox cycling rather than unidirectional reactions. The reducing acid does not eliminate oxidized iodine species, but participates in reversible redox balance. The organic physiological acid, such as salicylic acid or its derivatives, contains the carboxyl (—COOH) or similar groups that operate as proton donors, and contributes to modulation of plant physiological signaling pathways, fine regulation of redox equilibrium, and stabilization of iodine species without suppressing redox activity. This physiological acid may cooperate functionally with the reducing acid but also serves a distinct biological role.

The redox-active iodine matrix is defined by functional cooperation and not a mandatory sequence. In an example embodiment, the reducing acid may establish redox balance, while the physiological acid may modulate signaling and system responsiveness. This is not limited to a strict order of addition, and redox cooperation may occur regardless of mixing sequence.

Non-ionic, biodegradable surfactants, such as alkyl polyglucosides, e.g., glucopan, may be used to stabilize reactive iodine species in aqueous solution, enhance dispersion and bioavailability, and prevent precipitation or uncontrolled volatilization. Crucially, the surfactant may stabilize iodine without chemically fixing it, thereby preserving redox activity. As noted above, there are proportional relationships that are important and add to iodine species ratios. The relative ratios of elemental iodine, iodide, and iodate may be selected to maintain both oxidized and reduced iodine pools within the matrix. The combined amount of organic reducing acid and organic physiological acid relative to total iodine species may range broadly, for example, from about 0.05:1 to about 10:1 by weight, but the ratios described relative to the experiments have been found beneficial.

In another example for the organic reducing acid and organic physiological acid, another range, e.g., about 0.1:1 to about 5:1, may provide optimized redox responsiveness and physiological modulation. The aqueous medium or solution for the redox-active iodine matrix composition may have a pH ranging from about 3 to about 7. In an example, a pH from about 4 to about 6 has been found beneficial to support reversible iodine redox cycling, chemical stability, and physiological compatibility. The pH may be used as a control variable and not merely as a formulation constraint. The redox-active iodine matrix composition may optionally be combined with additional components, such as amino acids or peptides, carbohydrates or polysaccharides, humic or fulvic substances, seaweed or plant extracts, and macro- or micronutrients with the ranges as described above. These components are included in amounts that do not disrupt the redox functionality of the iodine matrix.

In an example embodiment, the redox-active iodine matrix composition may be applied to plants, seeds, or growth media. Upon application, the iodine species may dynamically interconvert in response to plant redox conditions and elemental iodine may transiently form at biologically relevant interfaces. The physiological signaling pathways may be modulated rather than forced and the plant retains metabolic autonomy while benefiting from adaptive iodine availability. This behavior distinguishes the redox-active iodine matrix composition from static iodine fertilizers or iodate-based products.

The redox-active iodine matrix composition may operate as a platform technology and not a single-use formulation. The redox-active iodine matrix composition may be adapted to different crops, different formulation architectures, and different physiological targets. The composition operates as a redox-active signaling element, delivered through a chemically stabilized yet dynamically responsive matrix. This approach departs fundamentally from prior art iodine formulations that rely on passive delivery of a single iodine species.

Reference is made to the article by Humphrey et al., “Iodine Uptake, Storage and Translocation Mechanisms in Spinach (Spinacia oleracea L.),” Environmental Geochemistry and Health, 41(3), Mar. 8, 2019, which describes iodine uptake and transformation in plants. This study shows that plants actively absorb iodate and iodide and that iodate may be reduced to iodide within plant tissues, highlighting that iodine speciation and redox state may be biologically relevant during plant interaction.

The redox-active iodine matrix composition delivers iodide after uptake as a preconfigured redox-active iodine matrix composition and includes multiple iodine species that are capable of dynamic interconversion in the composition itself. The redox-active iodine matrix composition may modulate plant physiological processes and may include elemental iodine (I₂) and iodide (I⁻) in an aqueous medium at a weight ratio from about 1:1.2 to about 1:5, and iodate (IO₃⁻) present in the aqueous medium at a weight ratio from about 1:0.5 to about 1:5 relative to the combined weight of elemental iodine and iodide. The organic reducing acid may include ascorbic acid or a derivative thereof. An organic physiological acid may include salicylic acid or a derivative thereof. At least one non-ionic, biodegradable surfactant may be included. The composition forms a redox-active iodine matrix composition that dynamically interconverts iodine species in the aqueous medium. Thus, a redox-active iodine matrix is formed that goes beyond a static iodine composition.

The non-ionic, biodegradable surfactant may be present at a weight ratio from about 3:1 to about 20:1 relative to the combined weight of elemental iodine and iodide, which aids in anchoring the surfactant proportions for stabilization of the iodine system. The non-ionic, biodegradable surfactant may include an alkyl polyglucoside (APG) as a biodegradable, non-phenolic surfactant. The alkyl polyglucoside may be derived from fatty alcohols having C8-C16 alkyl chains and glucose units, such as glucopan. The organic reducing acid and the organic physiological acid may be present at a combined weight ratio relative to total iodine species from about 0.05:1 to about 10:1 to provide broad proportional coverage between acids and iodine species. The organic reducing acid may be present in an amount effective to regulate reversible oxidation-reduction interconversion between iodine species, which helps functionally and link the reducing acid to redox control.

The aqueous medium may have a pH from about 3 to about 7, and preferably from about 4 to about 6, to support reversible iodine redox cycling as determined above. This helps define the pH range as a redox-modulating parameter. The iodine is not maintained in a fixed oxidation state, but is reversibly cycled among iodine species within the redox-active iodine matrix as compared to iodate-only or single-species iodine formulations. The non-ionic, biodegradable surfactant may stabilize reactive iodine species while preserving redox functionality in the aqueous medium, thus, stabilizing the composition without suppression of redox activity. One or more additional components may be selected from amino acids, peptides, proteins, carbohydrates, polysaccharides, humic substances, fulvic acids, seaweed extracts, plant extracts, micronutrients, macronutrients, or combinations thereof with the ranges described above for specific components. This allows compatibility with complex agricultural formulations.

Additional components may be present in amounts that do not disrupt the redox-active iodine matrix composition in order to protect the functional integrity of the composition. Plant physiological responses may be modulated applying the composition to a plant, seed, or plant growth medium and may include enhanced nutrient assimilation, stress tolerance, metabolic efficiency, or growth regulation mediated by the redox-active iodine matrix composition.

The redox-active iodine matrix composition may function as a physiological signaling modulator rather than only a fixed nutrient source and provides reversible iodine availability that is responsive to endogenous plant redox conditions. The redox-active iodine matrix composition may modulate physiological processes through dynamic iodine redox behavior, rather than a specific product type having a single oxidation state component that does not interconvert iodine species, such as a conventional fertilizer, growth regulator, or single-use formulation.

Recent plant physiology studies indicate that iodine may play a functional biological role in plants beyond simple micronutrient activity. Research has demonstrated that iodine treatments can influence plant gene expression, antioxidant activity, and physiological responses to stress conditions. There is also evidence that indicates iodine may be incorporated into plant proteins and can participate in plant metabolic processes. Studies indicate a biological role of iodine in plants and suggest that iodine interacts with plant antioxidant systems and may influence oxidative stress responses.

As noted before, plants may maintain redox balance through complex antioxidant systems involving enzymatic and non-enzymatic pathways. Non-limiting examples of key systems include the ascorbate-glutathione cycle, thiol-based redox systems, and antioxidant enzymes such as catalase and peroxidases. These systems regulate reactive oxygen species (ROS) levels and maintain cellular homeostasis. The redox-active iodine matrix composition uses iodine chemistry to interact with these plant redox systems.

As described above, the redox-active iodine matrix composition includes a redox-active iodine matrix that may contain multiple iodine oxidation states capable of reversible redox interconversion. Non-limiting examples of the redox-active iodine matrix composition include combinations of elemental iodine (I₂), iodide (I⁻), and iodate (IO₃⁻) in combination with organic reducing agents and physiological organic acids. These species may interconvert through reversible reactions, such as I2 [symbol] I⁻ and I⁻ [symbol] IO₃⁻. The presence of these species creates a dynamic redox equilibrium capable of regenerating molecular iodine within the system. This dynamic equilibrium maintains a controlled pool of bioactive iodine species.

The redox-active iodine matrix composition functions as an electron-buffering system capable of modulating redox conditions within plant tissues. Electron buffering refers to the ability of a chemical system to accept electrons during oxidative conditions, donate electrons during reductive conditions, and maintain redox equilibrium through reversible reactions. Because iodine can exist in multiple oxidation states, iodine-containing systems can function as redox mediators. Within the redox-active iodine matrix composition, iodine species may participate in reversible electron transfer reactions with organic reducing agents. This mechanism allows the composition to stabilize redox fluctuations in plant tissues.

Organic reducing agents may be included to regulate iodine redox reactions. Examples of such reducing agents include ascorbic acid, other organic reducing acids, polyphenols, and plant-compatible antioxidants. For example, ascorbic acid may reduce elemental iodine to iodide through reactions, such as I₂+ascorbate→I⁻+dehydroascorbate. This reaction allows dynamic regeneration of iodine species within the matrix. The combined concentration of reducing agents relative to iodine species may be adjusted to maintain controlled redox activity.

Plants may regulate intracellular redox balance through the ascorbate-glutathione cycle. This cycle involves electron transfer between ascorbate, glutathione, dehydroascorbate, and glutathione disulfide. The redox-active iodine matrix composition as a redox-active iodine system may interact with this endogenous cycle. In some examples, thiol-containing antioxidants may be included. Non-limiting examples include reduced glutathione (GSH) oxidized glutathione (GSSG) cysteine, N-acetylcysteine (NAC) and other thiol-containing compounds. These compounds may participate in reversible redox reactions with iodine species. Through these interactions, the redox-active iodine matrix composition may influence plant antioxidant systems and redox signaling pathways.

Physiological organic acids may also be included to modulate plant responses. Non-limiting examples include salicylic acid, derivatives of salicylic acid, phenolic acids, and iodinated salicylate derivatives. Salicylic acid is known to participate in plant defense signaling pathways and may influence oxidative stress responses. These components may contribute to physiological modulation and stabilization of reactive iodine species.

In certain embodiments, non-ionic biodegradable surfactants may be included. These surfactants may stabilize iodine species in aqueous solutions, improve dispersion and plant surface interaction, and facilitate delivery of the redox matrix to plant tissues. Suitable surfactants may include plant-compatible non-ionic surfactants capable of stabilizing reactive iodine species without suppressing redox cycling.

By providing a dynamic pool of iodine species and reducing agents, the redox-active iodine matrix composition may act as a redox buffer for plant metabolism. Potential physiological effects include modulation of reactive oxygen species balance, stimulation of antioxidant defense systems, regulation of plant stress signaling pathways, and improvement of plant resilience under environmental stress. Unlike conventional fertilizers, the redox-active iodine matrix composition may influence plant physiology primarily through redox modulation mechanisms rather than direct nutrient supplementation.

A beneficial aspect of the redox-active iodine matrix composition is the controlled regeneration of molecular iodine. Through redox interactions with reducing agents, iodine species may continuously interconvert. This mechanism maintains a bioactive iodine pool while preventing accumulation of phytotoxic concentrations.

The redox-active iodine matrix composition provides a redox-active iodine system functioning as an electron-buffering matrix for plant physiology. The composition as a redox-active iodine matrix integrates multiple iodine oxidation states, organic reducing agents, physiological organic acids, optional thiol antioxidants, and surfactant stabilization. Together these components create a dynamic redox environment capable of interacting with plant antioxidant systems and modulating plant physiological responses.

In an example, the plant treatment composition may include multiple iodine species such as elemental iodine, iodide, and iodate and at least one organic reducing agent. At least one physiological organic acid may be included and the composition forms a redox-active iodine matrix capable of reversible redox interconversion between iodine species.

The redox-active iodine matrix composition may function as an electron-buffering system capable of accepting and donating electrons under varying redox conditions. The organic reducing agent may include ascorbic acid or a derivative thereof. A thiol-containing antioxidant may include one or more of glutathione, cysteine, N-acetylcysteine, or derivatives thereof.

The physiological organic acid may include salicylic acid or a derivative thereof. The iodine species may undergo continuous reversible redox cycling between I2, I⁻, and IO₃. The composition interacts with plant antioxidant systems including the ascorbate-glutathione redox cycle. A non-ionic biodegradable surfactant may be capable of stabilizing reactive iodine species. The composition may provide controlled regeneration of molecular iodine through redox reactions with organic reducing agents.

A method of modulating plant physiological responses may include applying the composition to a plant or plant surface, and may include one or more of foliar spraying, trunk injection and soil drenching. The composition may modulate plant metabolism through redox buffering mechanisms. The iodine species may function as redox mediators capable of facilitating electron transfer reactions within plant biochemical systems. The redox-active iodine matrix composition may be capable of modulating oxidative and reductive biochemical processes within plant tissues. The redox-active iodine matrix composition may provide controlled bioavailability of molecular iodine through reversible redox reactions with organic reducing agents. The dynamic redox cycling of iodine species maintains bioactive iodine concentrations below phytotoxic levels. It is possible to regulate plant redox balance by applying to a plant the composition, which may enhance plant resilience to abiotic or biotic stress through redox modulation.

In the following description, the abbreviations apply when used: Iodate (IO₃⁻); iodide (I—); potassium iodate (KIO₃); Hypoiodous acid (HIO); Iodine (I₂); Salicylic acid (SA); glyceraldehyde-3-phosphate dehydrogenase C sub 1 (GAPC1); glutathione (GSH); ascorbic acid (AsA); and reactive oxygen species (ROS).

There now follows a description of a possible mechanism of iodine uptake and iodine-induced molecular responses in plants. KIO₃ is converted into IO₃⁻, which is metabolized into I⁻, HIO, and I₂ in the apoplast and is transported into the cytoplasm via different channels and transporters. It is believed that the I— in the cell may directly iodinate proteins or induce gene expression indirectly.

Increased cellular iodine has been shown to have a role in the detoxification of stress-induced ROS and in controlling the redox status of the plant cell. The iodination of several proteins involved in the maintenance and stability of photosynthetic protein complexes has been observed with a key enzyme of glycolysis (GAPC1), several cell-wall-related proteins, and a number of class III peroxidases involved in redox regulation. Iodine species may trigger the transcription of various photosynthesis-related genes and genes involved in salicylic acid (SA) metabolism, and several stress and hypoxia-induced and defense-related genes. Many of the iodine-regulated genes may overlap with those controlled by SA/ROS. Iodine may control stress and defense-related gene expression by affecting ROS and/or SA metabolism. The regulation may be activation or inhibition.

The redox-active iodine matrix composition sustains reversible interconversion among multiple iodine species within plant tissues. This behavior is consistent with known iodine uptake, transport, and redox processes reported in plants. Iodine species introduced to the plant environment may be taken up through transporters or channels and undergo redox interconversion in the apoplast and intracellular compartments, generating a dynamic equilibrium among iodide (I⁻), hypoiodous acid (HIO), molecular iodine (I₂), and related species. These interconversions are facilitated and buffered by endogenous redox-active compounds naturally present in plant cells.

In particular, low-molecular-weight antioxidants, such as ascorbic acid (AsA) and glutathione (GSH), participate in maintaining a reversible and controlled redox environment, allowing iodine species to remain biologically active while avoiding irreversible oxidation or depletion. The presence of these redox buffers enables the iodine matrix to function as a sustained redox signaling resource rather than a static nutrient source. The dynamic iodine redox pool may interact with cellular redox networks involved in the regulation of reactive oxygen species (ROS), contributing to redox homeostasis under both normal and stress conditions. Iodine species may influence the activity or expression of antioxidant systems and redox-sensitive metabolic pathways without imposing a forced biochemical outcome.

Iodine-mediated redox signaling may intersect with salicylic acid (SA)-related pathways, including genes and responses associated with stress adaptation and defense signaling. The overlap between iodine-responsive pathways and SA/ROS-regulated pathways permits iodine to function as a modulatory element within broader physiological signaling networks.

Accordingly, the redox-active iodine matrix composition as described provides plants with a flexible and adaptive redox resource that supports physiological balance, metabolic stability, and stress responsiveness. This framework may explain the beneficial and positive observed experimental outcomes explained above and shown in the drawings associated with the redox-active iodine matrix composition as described above and remain applicable across different plant species, environmental conditions, and formulation variations. This applies even when additional and/or alternative components are added to the redox-active iodine matrix composition.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A composition formulated as a biostimulant for plant growth, comprising:
elemental iodine and potassium iodide in an aqueous solution at a weight ratio of about 1:1.2 to 1:5;
potassium iodate in the aqueous solution at a weight ratio of about 1:0.5 to 1:5 to the combined weight of the elemental iodine and potassium iodide;
ether-nonyl polyglycol ethoxylate in the aqueous solution at a weight ratio of about 3:1 to 20:1 to the combined weight of the elemental iodine and potassium iodide to emulsify the elemental iodine and enhance its stability;
a first stabilizing agent comprising salicylic acid in the aqueous solution at a weight ratio of about 1:0.2 to 1:10 to the elemental iodine; and
a second stabilizing agent comprising ascorbic acid in the aqueous solution in an amount to enhance solubility and bioavailability of iodine and impart to the aqueous solution a pH between about 4 and 6.

2. The composition of claim 1, comprising at least one surfactant as one or more of Nonylphenol Ethoxylates;
Alcohol ethoxylates/alkoxylates; Sorbitan ester ethoxylates;
Alkyl polyglucosides (APG); Polyvinylpyrrolidones (PVP); and
Ethylene oxide-propylene oxide copolymers.

3. The composition of claim 1, wherein the ether-nonyl polyglycol ethoxylate has an ethylene oxide mole number greater than 4 and up to 30.

4. The composition of claim 1, further comprising at least one of a) about 0.5% to about 1.5% w/w of a soluble seaweed extract in the aqueous solution, b) about 1.5% to about 2.5% w/w of soy protein hydrolysate amino acids in the aqueous solution, c) about 10% to about 20% w/w of combined nitrogen, phosphorus, potassium and sulfur in the aqueous solution, d) about 4% to about 7% w/w of combined chelated calcium, magnesium, microorganisms, humic acids, fulvic acids and carboxylic acids in the aqueous solution, and e) about 12% to about 16% w/w of combined potassium nitrate, calcium and soy protein hydrolysate amino acids in the aqueous solution.

5. A method for stimulating plant growth, comprising:
applying a composition to the plant that is formulated as a biostimulant for the plant growth, the composition comprising:
elemental iodine and potassium iodide in an aqueous solution at a weight ratio of about 1:1.2 to 1:5;
potassium iodate in the aqueous solution at a weight ratio of about 1:0.5 to 1:5 to the combined weight of the elemental iodine and potassium iodide;
ether-nonyl polyglycol ethoxylate in the aqueous solution at a weight ratio of about 3:1 to 20:1 to the combined weight of the elemental iodine and potassium iodide to emulsify the elemental iodine and enhance its stability;
a first stabilizing agent comprising salicylic acid in the aqueous solution at a weight ratio of about 1:0.2 to 1:10 to the elemental iodine; and
a second stabilizing agent comprising ascorbic acid in the aqueous solution in an amount to enhance solubility and bioavailability of iodine and impart to the aqueous solution a pH between about 4 and 6.

6. The method of claim 5, comprising immersing a seed for about 4 to 12 hours within the aqueous solution as the composition before sowing the seed to grow into the plant.

7. The method of claim 5, comprising foliar spraying the composition onto the plant about every 5 to 10 days while the plant grows in a nursery.

8. The method of claim 5, comprising foliar spraying about every 12 to 18 days the composition onto the plant transplanted from the nursery to a field.

9. The method of claim 5, comprising at least one surfactant as one or more of Nonylphenol Ethoxylates; Alcohol ethoxylates/alkoxylates; Sorbitan ester ethoxylates; Alkyl polyglucosides (APG); Polyvinylpyrrolidones (PVP); and Ethylene oxide-propylene oxide copolymers.

10. The method of claim 5, wherein the ether-nonyl polyglycol ethoxylate has an ethylene oxide mole number greater than 4 and up to 30.

11. The method of claim 5, further comprising at least one of a) about 0.5% to about 1.5% w/w of a soluble seaweed extract in the aqueous solution, b) about 1.5% to about 2.5% w/w of soy protein hydrolysate amino acids in the aqueous solution, c) about 10% to about 20% w/w of combined nitrogen, phosphorus, potassium and sulfur in the aqueous solution, d) about 4% to about 7% w/w of combined chelated calcium, magnesium, microorganisms, humic acids, fulvic acids and carboxylic acids in the aqueous solution, and e) about 12% to about 16% w/w of combined potassium nitrate, calcium and soy protein hydrolysate amino acids in the aqueous solution.

12. A composition for modulating plant physiological processes, comprising:
elemental iodine (I₂) and iodide (I⁻) in an aqueous medium at a weight ratio from about 1:1.2 to about 1:5;
iodate (IO₃⁻) present in the aqueous medium at a weight ratio from about 1:0.5 to about 1:5 relative to the combined weight of elemental iodine and iodide;
an organic reducing acid comprising ascorbic acid or a derivative thereof;
an organic physiological acid comprising salicylic acid or a derivative thereof; and
at least one non-ionic, biodegradable surfactant,
wherein the composition forms a redox-active iodine matrix that interconverts iodine species in the aqueous medium.

13. The composition of claim 12, wherein the non-ionic, biodegradable surfactant is present at a weight ratio from about 3:1 to about 20:1 relative to the combined weight of elemental iodine and iodide.

14. The composition of claim 12, wherein the non-ionic, biodegradable surfactant comprises an alkyl polyglucoside (APG).

15. The composition of claim 12, wherein the organic reducing acid and the organic physiological acid are present at a combined weight ratio relative to total iodine species from about 0.05:1 to about 10:1.

16. The composition of claim 15, wherein the organic reducing acid is present in an amount effective to regulate reversible oxidation-reduction interconversion between iodine species.

17. The composition of claim 12, wherein the aqueous medium has a pH from about 3 to about 7 to support reversible iodine redox cycling.

18. The composition of claim 12, wherein iodine is reversibly cycled among iodine species within the redox-active iodine matrix.

19. The composition of claim 12, wherein the non-ionic, biodegradable surfactant is present in a concentration to stabilize reactive iodine species while preserving redox functionality in the aqueous medium.

20. A method for modulating plant physiological responses comprising applying a composition to a plant, seed, or plant growth medium, the composition, comprising:
elemental iodine (I₂) and iodide (I⁻) in an aqueous medium at a weight ratio from about 1:1.2 to about 1:5;
iodate (IO₃⁻) present in the aqueous medium at a weight ratio from about 1:0.5 to about 1:5 relative to the combined weight of elemental iodine and iodide;
an organic reducing acid comprising ascorbic acid or a derivative thereof;
an organic physiological acid comprising salicylic acid or a derivative thereof; and
at least one non-ionic, biodegradable surfactant,
wherein the composition forms a redox-active iodine matrix that interconverts iodine species in the aqueous medium.

21. The method of claim 20, comprising immersing a seed for about 4 to 12 hours within the aqueous solution as the composition before sowing the seed to grow into the plant.

22. The method of claim 20, comprising foliar spraying the composition onto the plant about every 5 to 10 days while the plant grows in a nursery.

23. The method of claim 20, comprising foliar spraying about every 12 to 18 days the composition onto the plant transplanted from the nursery to a field.

24. The method of claim 20, wherein the modulation comprises enhanced nutrient assimilation, stress tolerance, metabolic efficiency, or growth regulation mediated by the redox-active iodine matrix.

25. A plant treatment composition comprising:
a plurality of iodine species selected from elemental iodine, iodide, and iodate;
at least one organic reducing agent;
at least one physiological organic acid; and
wherein the composition forms a redox-active iodine matrix capable of reversible redox interconversion between iodine species.

26. The composition of claim 25, wherein the organic reducing agent comprises ascorbic acid or a derivative thereof.

27. The composition of claim 25, further comprising a thiol-containing antioxidant selected from glutathione, cysteine, N-acetylcysteine, or derivatives thereof.

28. The composition of claim 25, wherein the physiological organic acid comprises salicylic acid or a derivative thereof.

29. The composition of claim 25, wherein the iodine species undergo continuous reversible redox cycling between I₂, I⁻, and IO₃⁻.

30. The composition of claim 25, wherein the composition interacts with plant antioxidant systems including the ascorbate-glutathione redox cycle.

31. The composition of claim 25, further comprising a non-ionic biodegradable surfactant capable of stabilizing reactive iodine species.

32. The composition of claim 25, wherein the composition provides controlled regeneration of molecular iodine through redox reactions with organic reducing agents.

33. The composition of claim 25, wherein the iodine species function as redox mediators capable of facilitating electron transfer reactions within plant biochemical systems.

34. The composition of claim 25, wherein the redox-active iodine matrix is capable of modulating oxidative and reductive biochemical processes within plant tissues.

35. The composition of claim 25, wherein the redox matrix provides controlled bioavailability of molecular iodine through reversible redox reactions with organic reducing agents.

36. The composition of claim 25, wherein the dynamic redox cycling of iodine species maintains bioactive iodine concentrations below phytotoxic levels.

37. A method of modulating plant physiological responses comprising applying the composition of claim 25 to a plant or plant surface.

38. The method of claim 37, wherein the composition modulates plant metabolism through redox buffering mechanisms.

39. A method for regulating plant redox balance comprising applying to a plant the composition of claim 25.

40. The method of claim 39, wherein the composition enhances plant resilience to abiotic or biotic stress through redox modulation.
